(19) United States
(12) Patent Application Publication
(10) Pub. No.: US 2016/0363108 A1
(43) Pub. Date: Dec. 15, 2016

(54) IGNITION SYSTEM WITH SPARK DISCHARGE TRUNCATION

(71) Applicant: DELPHI TECHNOLOGIES, INC., TROY, MI (US)

(72) Inventors: COLIN HAMER, NOBLESVILLE, IN (US); ALBERT A. SKINNER, WATERFORD, MI (US)

(21) Appl. No.: 14/734,129

(22) Filed: Jun. 9, 2015

(51) Int. Cl. F02P 3/045; F02P 7/03; H01F 38/12

(52) U.S. Cl. CPC F02P 3/045; H01F 38/12; F02P 7/03

(57) ABSTRACT

An ignition system for a spark ignition internal combustion engine includes a transformer, a switching device, a spark-plug, and a controller. The switching-device is operable to an off-state, an on-state, and a linear-state to control a primary current through a primary coil and a secondary current through a secondary coil. The controller is configured to receive a single control-signal that includes a spark-control portion followed by a snubbing-control portion, and operate the switching-device based on the single control-signal. The controller operates the switching device from the off-state to the on-state and back to the off-state in response to the spark-control portion, whereby the secondary current is sufficient for the spark-plug to generate a spark, and operates the switching-device from the off-state to the on-state followed by the linear-state in response to the snubbing-control portion, whereby the secondary current is suppressed such that the spark-plug does not generate a spark.

### TECHNICAL FIELD OF INVENTION

This disclosure generally relates to a vehicle ignition system, and more particularly relates to a system configured to actively truncate or terminate a spark discharge.

### BACKGROUND OF INVENTION

Ignition systems with long burn times, i.e. long spark-plug discharge times, have been proposed. However, excessive discharge times may cause undesirable increased spark-plug electrode erosion, and/or cause a spark-plug to have a spark discharge after the opening of the intake valve for the next combustion event. The risk of this occurring increases at high engine speeds and cold temperatures where the resistive losses are less and limited spark-plug discharge times are required.

### SUMMARY OF THE INVENTION

In accordance with one embodiment, an ignition system for use with a spark ignition internal combustion engine is provided. The system includes a transformer, a switching device, a spark-plug, and a controller. The transformer includes a primary coil and a secondary coil. The switching-device is coupled to the primary coil and operable to an off-state, an on-state, and a linear-state to control a primary current through the primary coil and a secondary current through the secondary coil. The spark-plug is coupled to the secondary coil. The controller is configured to receive a single control-signal that includes a spark-control portion followed by a snubbing-control portion, and operate the switching-device based on the single control-signal. The controller operates the switching device from the off-state to the on-state and back to the off-state in response to the spark-control portion, whereby the secondary current is sufficient for the spark-plug to generate a spark. The controller also operates the switching-device from the off-state to the on-state followed by the linear-state in response to the snubbing-control portion, whereby the secondary current is suppressed such that the spark-plug does not generate a spark.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is diagram of an ignition system in accordance with one embodiment;

FIG. 2 is a diagram of a controller in the system of FIG. 1 in accordance with one embodiment; and

FIG. 3 is a diagram of a snubbing control block in the controller of FIG. 2 in accordance with one embodiment.

### DETAILED DESCRIPTION

Described herein is an ignition system that provides a simple “snubbing” feature that in one non-limiting example requires very little added circuitry over what is needed for the basic ignition function. A common feature required by some auto makers, is a ‘soft shutdown’, which is typically used if an excessive dwell (error by ECM) occurs. The soft shutdown controls the rate at which the primary current is turned off in order to keep the secondary voltage below a voltage that will breakdown the spark gap and initiate a spark discharge. This system described herein utilizes the soft shutdown as part of a “snubbing” method to terminate or truncate a spark discharge.

In one non-limiting example described in more detail below, the ignition driver used to control primary current to the primary coil is turned ON when an end or truncation of an on-going spark discharge is desired. Due to the nature of the spark discharge provided by a typical non-linear coil (i.e. ignition transformer), the high secondary current portion (50 mA to 250 mA) is less than 50% of the initial secondary current at the beginning of the spark discharge. The truncated current therefore is not very high, typically less than 50 mA. With the secondary current under 50 mA, the primary current that occurs when the IGBT is turned on will climb rapidly to about 5 A. The increasing primary current will end the decay of magnetic flux and start to build increased flux as the current increases at a rate set by the natural inductance of the primary circuit. When the decrease of the flux is ended, the voltage induced on the secondary goes to zero thereby ending or truncating the spark discharge. The typical time required to end the discharge is in the order of <0.1 msec. After the primary coil achieves a primary current sufficient to end the spark discharge, the ‘soft shutdown’ feature may be activated to prevent a subsequent spark discharge from occurring with the energy that remains in the coil.

In one embodiment, a controller of the ignition system receives a single control-signal with both a spark-control portion followed by a snubbing-control portion embedded. The controller is configured to differentiate between the spark-control portion (i.e. a normal dwell signal, and the snubbing-control portion (i.e. a truncate dwell signal). The snubbing-control portion or the truncate dwell signal may be of a different voltage level than the spark-control portion or the normal dwell signal, or time intervals may be measured by the controller to determine the action indicated by the single control signal. For example, the controller may be configured to determine that any dwell shorter than “X” (i.e. 0.1 msec) is the snubbing-control portion. Accordingly, the controller is configured to operate a switching-device (e.g. an IGBT) based on the single control-signal. If a spark-control portion is detected, then the controller operates the switching device from the off-state to the on-state and back to the off-state in order to generate a secondary voltage sufficient to initiate a spark discharge, and a secondary current is sufficient to maintain the spark discharge for a minimum desired time.

Otherwise, if a snubbing-control portion is detected, the controller operates the switching-device from the off-state to the on-state followed by the linear-state whereby the secondary current is suppressed such that the spark-plug does not generate a spark. That is, when a snubbing-control portion is detected, i.e. when a truncate signal is received, the switching-device is either turned on for a predetermined time period to guarantee that the spark discharge is extinguished, or the secondary current may be sensed to determine when the discharge has ended, and then the soft shutdown may be used to prevent a spark discharge.

Alternatively, the system may include a second IGBT in parallel with the primary coil that when turn on is also effective to truncate the spark discharge. This may be desirable from a power dissipation aspect to reduce the temperature rise of the main IGBT. Also, if a second IGBT is used it may be current limited to a value that would always allow the spark to be extinguished (i.e.5 A). This would reduce the heat generated in the primary winding if the dwell to truncate the spark was excessive for any reason.

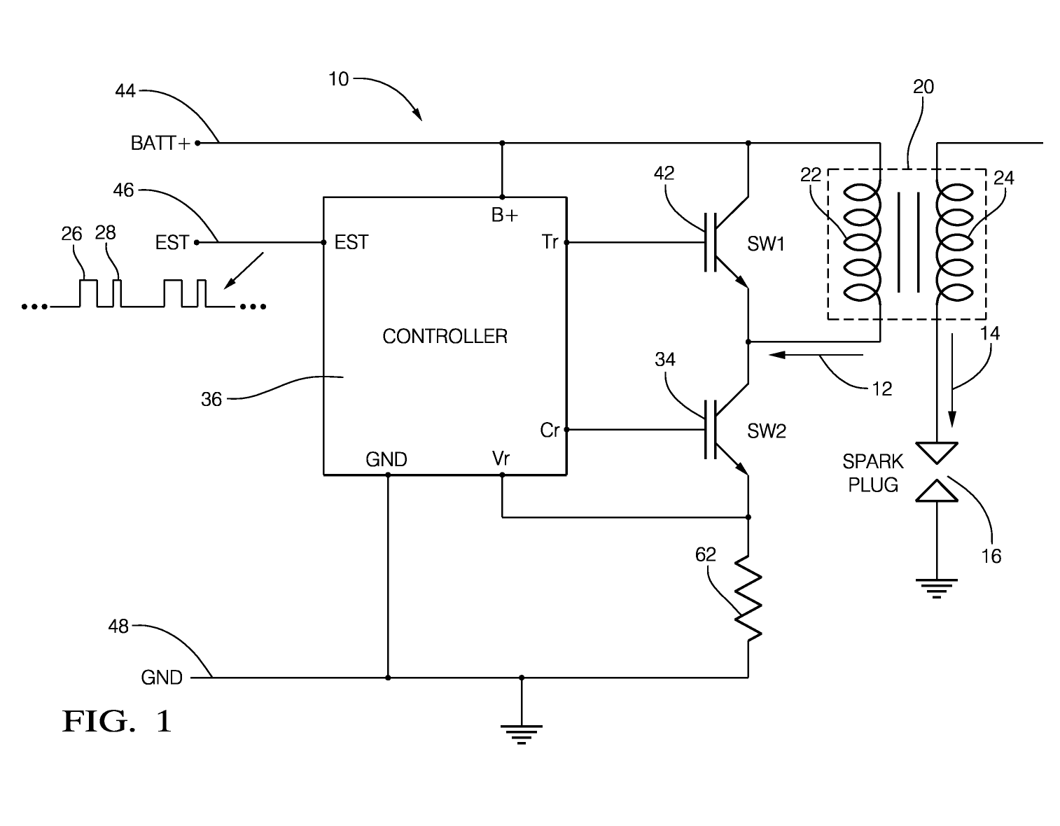

FIG. 1 illustrates a non-limiting example of an ignition system 10, hereafter referred to as the system 10, suitable for use with a spark ignition internal combustion engine (not shown). As will be recognized by those in the art, the system 10 includes a transformer 20 that includes a primary coil 22 and a secondary coil 24, and a switching-device 34 (e.g. an IGBT) coupled to the primary coil 22. The switching-device 34 is operable to an off-state, an on-state, and a linear-state to control a primary current 12 through the primary coil 22, and a secondary current 14 through the secondary coil 24. The system 10 also includes a spark-plug 16 coupled to the secondary coil 24. Those in the ignition arts will recognize that a relatively long duration spark discharge may be maintained if the secondary current 14 is sufficient to generate an adequate voltage across the gap of the spark-plug 16. That is, a spark discharge may be maintained for as long as desired given that a sufficient amount of magnetic energy is stored in the core of the transformer 20.

The system 10 includes a controller 36 configured to receive a single control-signal 46, sometimes referred to as the electronic spark timing signal or EST. In this non-limiting example the single control-signal 46 includes a spark-control portion followed by a snubbing-control portion. WIPO publication WO2015/009594 published Jan. 22, 2015 and owned by the same assignee as this application describes a way that multiple signal portions can be presented in a single signal.

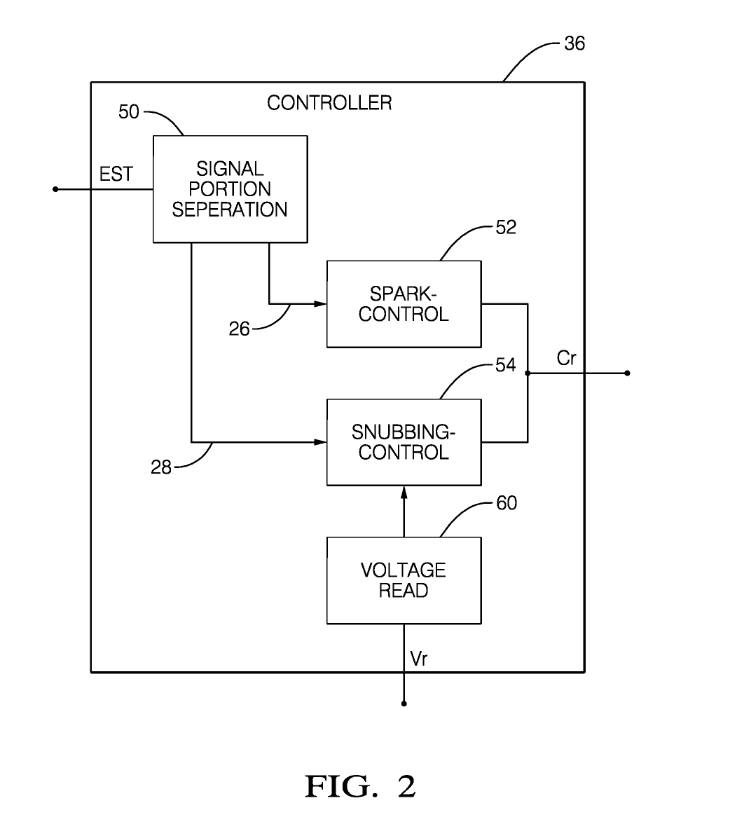

FIG. 2 illustrates some details of a non-limiting example of the controller 36. In this example, the controller 36 includes a signal-portion-separator 50 that separates or extracts the spark-control portion 26 and the snubbing-control portion 28 from the single control-signal 46 and provides those separated signals to spark-control block 52 and a snubbing-control block 54. As such, the controller is configured to operate the switching-device 34 based on the single control-signal 46. The controller 36, or more specifically the spark-control block 52, is configured to operate the switching-device 34 from the off-state to the on-state and back to the off-state in response to the spark-control portion 26 so that the secondary current 14 is sufficient for the spark-plug 16 to generate a spark. The controller 36, or more specifically the snubbing-control block 54, is also configured to operate the switching-device 34 from the off-state to the on-state followed by the linear-state in response to the snubbing-control portion 28 so that the secondary current 14 is suppressed such that the spark-plug 16 does not generate a spark.

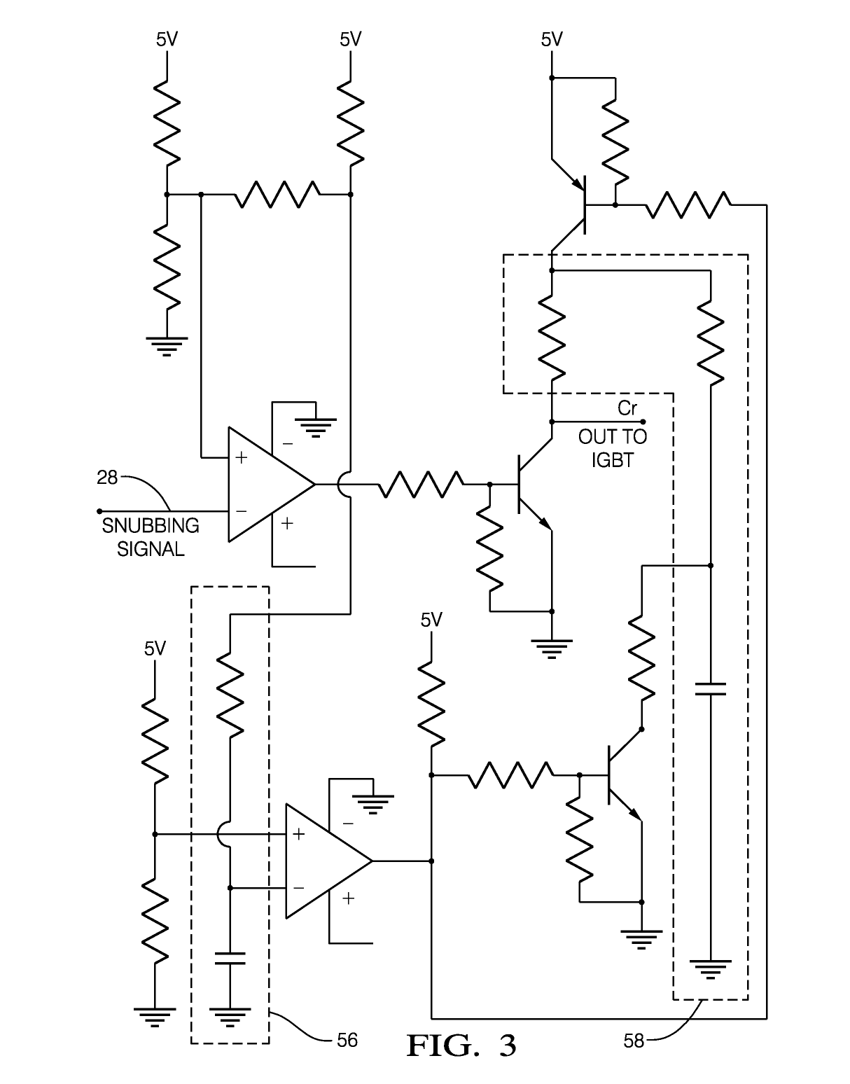

FIG. 3 illustrates some details of a non-limiting example of the snubbing-control block 54. In general, the snubbing-control block receives a relatively squared edged pulse that is the snubbing-control portion 28 of the single control-signal 46 received by the system 10, and transforms that pulse into a shaped waveform at the switching-device 34 by operating the switching-device 34 in such a way as to prevent generation of spark discharge by the spark-plug 16. In this example, the on-timer section 56 slows the rate that the switching-device 34 transitions from the off-state to the on-state to prevent spark discharge by the spark-plug 16. Similarly, the off-timer section 58 slows the rate that the switching-device 34 transitions from the on-state to the linear-state to also prevent spark discharge by the spark-plug 16.

It is noted that the snubbing-control block 54 illustrated does not make use of the signal output by the voltage read block 60 (FIG. 2) as control of the signal to the IGBT (Cr) is based on timers. Alternatively, the function of the snubbing-control block 54 could be provided by a circuit that monitors the voltage drop across a current sense resistor 62 (FIG. 1). Another alternative is to employ a microprocessor within the snubbing-control block 54 to execute a combination of time-based logic and sensed-current logic to control the switching-device 34 in a manner that prevents undesired spark discharges by the spark-plug 16.

Accordingly, an ignition system (the system 10), capable of producing an extended duration spark discharge, but also capable of truncating that spark discharge at a desired time is provided. By providing the means to truncate or snub a spark discharge, unnecessary electrode wear can be avoided, and the risk of a spark discharge when the intake valve is open can also be avoided.

While this invention has been described in terms of the preferred embodiments thereof, it is not intended to be so limited, but rather only to the extent set forth in the claims that follow.

1. An ignition system for use with a spark ignition internal combustion engine, said system comprising:
a transformer that includes a primary coil and a secondary coil;
a switching-device coupled to the primary coil and operable to an off-state, an on-state, and a linear-state to control a primary current through the primary coil and a secondary current through the secondary coil;
a spark-plug coupled to the secondary coil; and
a controller that includes a signal-portion-separator used to receive a single control-signal, extract a spark-control portion and extract a snubbing-control portion from the single control-signal, wherein the controller operates the switching device from the off-state to the on-state and back to the off-state in response to the spark-control portion whereby the secondary current is sufficient for the spark-plug to generate a spark, and operates the switching-device from the off-state to the on-state followed by the linear-state in response to the snubbing-control portion whereby the secondary current is suppressed such that the spark-plug does not generate a spark.
